(19) United States
(12) Patent Application Publication
(10) Pub. No.: US 2003/0200324 A1
(43) Pub. Date: Oct. 23, 2003

(54) Apparatus and method for protocol processing, and apparatus and method for traffic processing

(75) Inventor: Min-Seop Jeong, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/382,908

(22) Filed: Mar. 7, 2003

(30) Foreign Application Priority Data
Mar. 7, 2002 (KR) 2002-12227

(51) Int. Cl. G06F 15/16

(52) U.S. Cl. 709/230

(57) ABSTRACT

An apparatus and method of processing protocols and traffic are disclosed. An assembling and segmenting portion assembles input cells to generate data packets and segments the data packets to regenerate the cells. A lower layer protocol processing portion processes lower layer protocols of sub-data packets extracted from a packet extracting portion. A higher layer protocol processing portion divides the sub-data packets into major packets and minor packets and processes them adaptively. Accordingly, traffic and protocols can be processed in a network system in which a master system and a plurality of slave systems are combined. Therefore, the size of the network system can be smaller.

### BACKGROUND OF THE INVENTION

1. Field of the Invention

The present invention relates to an apparatus for and method of processing protocols and traffics, and in particular to an apparatus for and method of processing protocol and traffic by combining a master and a plurality of slaves.

The present application is based on Korean Patent Application No. 2002-12227 filed on Mar. 7, 2002, which is incorporated herein by reference.

2. Description of the Prior Art

There is a router or a switch, etc., as a representative device for connecting a network to another network. The main functions of the router and switch are to transfer data packets to a wanted destination. For example, the router connects the Internet to an internal network line to transfer the data packets and make communication between them possible. To perform these functions, a network system itself processes data packet protocols.

As shown in FIG. 1, the conventional network system 100 includes a master 110 and a plurality of, namely n (n is a positive number), slaves 120.

After processing the same protocols, for example, Internet Protocol (IP) headers in data packets of received traffic, the master 110 distributes the data packets to any one of the slaves 120. Each slave 120 processes differently according to characteristics of each data, and re-transmits the processed data packets to the master 110.

FIG. 2 is a general block diagram of the conventional network system having a master and slaves, showing an embodiment of the system shown in FIG. 1.

Referring to FIG. 2, the master 110 includes a first assembling and segmenting portion 112, a packet storage portion 114, a header processor 116, and a packet analyzing portion 118. The first assembling and segmenting portion 112 relates to a Segmentation And Reassembly (SAR) layer belonging to a second layer of Open Systems Interconnection (OSI) 7 layers. The first assembling and segmenting portion 112 includes a first reassembling portion 112a and a first segmenting portion 112b. The first reassembling portion 112a assembles received Asynchronous Transfer Mode (ATM) cells or Ethernet-based cells into one data packet, and the first segmenting portion 112b segments the data packet into a plurality of cells.

When the ATM cells are received in the first reassembling portion 112a, the first reassembling portion 112a assembles the ATM cells to generate IP-based data packets. The generated data packets are stored in the packet storage portion 114. The header processor 116 is input with the data packets stored in the data packet storage portion 114 and processes IP headers. The packet analyzing portion 118 is a high speed searching device for analyzing input data packets. The packet analyzing portion 118 determines the processing method and transmission directions of the data packets based on the IP addresses. Then the packet analyzing portion 118 outputs determined signals and the data packets. The first segmenting portion 112b of the first assembling and segmenting portion 112 segments input data packets into ATM cells. Then, the first segmenting portion 112b selects one of the slaves 120 based on the information received from the packet analyzing portion 118, and transmits the ATM cells to the selected slave 120.

Each slave 120 includes a second assembling and segmenting portion 122 and a packet processor 124. The n slaves 120 perform different or identical functions corresponding to each protocol. The slaves 120 perform identical functions using distribution in order to increase processing speed. The second assembling and segmenting portion 122 relates to the same layer as the first assembling and segmenting portion 112. The second assembling and segmenting portion 122 includes a second reassembling portion 122a and a second segmenting portion 122b.

The second reassembling portion 122a of a slave 120 selected according to the determined signal transforms the ATM cells, which are inputted from the first segmenting portion 112b, into the data packets. The packet processor 124 processes specific protocols of the data packets and outputs them. The specific protocols are the protocols tat are not searched and analyzed by the master 110. The second segmenting portion 122b segments the data packets output from the packet processor 124 into the ATM cells and outputs them outside.

The conventional network system for processing protocols, however, has tendency of becoming large-sized as it needs a master and a plurality of slaves for processing the protocols. When the related network system receives cells to be processed, the master first processes common protocols, and then the slaves process each different protocol(s).

Namely, the conventional network system packetizes the input cells from the master 110 and processes common protocols of the packetized data. Then, the master segments the packetized data into cells and outputs them to the slaves. The slaves repacketizes input cells, processes protocols having each different characteristics, and resegments the repacketized data into cells of initial type. Based on these cell assembling and segmenting procedures, there are overheads, and a lot of time is required to process protocols. In addition, it is difficult for the master to distribute the data packets over the slaves efficiently.

SUMMARY OF THE INVENTION

Accordingly, it is an objective of the present invention to provide an apparatus and method for processing protocols and traffic of data packets using a network system whose master and slaves are combined.

To achieve the above object, there is provided an apparatus for processing protocols according to the present invention, including a major packet processor for analyzing at least one header of at least one major packet occupying a total number of input packets input from an outside source in a ratio greater than or equal to a predetermined ratio, in order to carry out additional processing related to a first protocol corresponding to at least one of said at least one header and at least one payload of said at least one major packet; and a minor packet processor for analyzing at least one header of at least one minor packet occupying the total number of packets in a ratio below the predetermined ratio, in order to carry out additional processing related to a second protocol corresponding to at least one of said at least one header and at least one payload of said at least one minor packet. Said at least one major packet is packetized according to the first protocol, and said at least one minor packet is packetized according to the second protocol, respectively.

Further provided are a first storage portion for storing the total number of input packets input from the outside; and a second storage portion for storing at least one of said at least one major packet and said at least one minor packet provided from at least one of the major packet processor and the minor packet processor, respectively, and outputting said at least one of said at least one major packet and said at least one minor packet to an outside destination.

The major packet processor includes a header processor for bypassing said at least one minor packet input from the outside, analyzing said at least one major packet header, and deciding if said additional processing related to the first protocol is required with respect to said at least one payload of said at least one major packet, a payload processor for carrying out the additional processing if the header processor decides that the additional processing related to the first protocol is required with respect to said at least one payload of said at least one major packet, and a minor packet provider for providing said at least one minor packet bypassed by the header processor, to the minor packet processor.

The payload processor bypasses said at least one major packet if the header processor does not decide that the additional processing is required with respect to said at least one payload of said at least one major packet. The minor packet provider selects a minor packet processor corresponding to the second protocol and provides said at least one minor packet bypassed to the selected minor packet processor. The minor packet provider selects at least one minor packet processor that's in an inactive state, sets an order of priority, and provides said at least one minor packet to the selected at least one minor packet processor.

The above object is also accomplished by a method for processing protocols according to the present invention, including the steps of (a) analyzing at least one major packet header occupying a total number of packets input from an outside source in a ratio greater than or equal to a predetermined ratio, deciding if additional processing related to a first protocol is required with respect to at least one major packet payload, and bypassing at least one minor packet occupying the total number of packets in a ratio below the predetermined ratio; and (b) carrying out the additional processing with respect to said at least one major packet payload if it is decided that the additional processing is required with respect to said at least one major packet payload in the step (a). Said at least one major packet is packetized according to said first protocol corresponding to said at least one major packet header and payload, and said at least one minor packet is packetized according to a second protocol corresponding to said at least one minor packet header and payload, respectively.

The major packets are packetized by the first protocol, and the minor packets are packetized by the second protocol, respectively.

Said at least one major packet bypasses the processing performed in step (b) if it is not decided that the additional processing is required with respect to said at least one major packet payloads in the step (a).

Further provided are the steps of (c) providing said at least one minor packet bypassed in the step (a) to one or more minor packet processing devices; and (d) analyzing at least one minor packet header to carry out the additional processing related to the second protocol with respect to at least one of headers and payloads of said at least one minor packet.

The step (c) comprises the sub-steps of selecting one of said one or more minor packet processing devices corresponding to the second protocol, and providing said at least one minor packet bypassed to the selected one of said one ore more minor packet processing devices. The step (c) comprises the sub-steps of selecting at least one of said one or more minor packet processing devices that is in an inactive state, setting an order of priority, and providing said at least one minor packet to the selected at least one minor packet processing devices.

According to the present invention, an apparatus for processing traffic includes an assembling and segmenting portion for assembling at least one input cell to generate at least one first data packet and segmenting another at least one data packet corresponding to said at least one first data packet to regenerate the cells; a packet extracting portion for extracting at least one sub-data packet including at least one header and at least one predetermined payload, from said-generated at least one first data packet; a lower layer protocol processing portion for analyzing lower layer protocol addresses of said at least one sub-data packet, and carrying out processing related to the lower layer protocol with respect to said at least one sub-data packet; a packet analyzing portion for analyzing the lower layer protocol addresses of said at least one sub-data packet to determine one or more paths through which said at least one sub-data packet is to be transmitted to external devices; and a higher layer protocol processing portion for processing at least one of at least one higher layer protocol header and at least one higher layer payload of said at least one sub-data packet to provide said at least one sub-data packet to the packet extracting portion.

Further provided is a payload storage portion for storing at least one residue payload excluding said at least one sub-data packet from said generated at least one first data packet. The assembling and segmenting portion includes an assembling portion for assembling said at least one input cell to generate said at least one first data packet; and a segmenting portion for segmenting said another at least one data packet to regenerate at least one cell, and outputting said at least one cell.

The higher layer protocol processing portion includes a major packet processing portion for analyzing at least one header of at least one major packet occupying said at least one sub-data packet input in a ratio greater than or equal to a predetermined ratio, and carrying out additional processing related to a first protocol corresponding to at least one of said at least one header of said at least one major packet and at least one payload of said at least one major packet; and a minor packet processing portion for analyzing at least one header of at least one minor packet occupying said at least one sub-data packet input in a ratio less than the predetermined ratio, and carrying out additional processing related to a second protocol corresponding to at least one of said at least one header and at least one payload of said at least one minor packet. Said at least one major packet is packetized according to the first protocol, and said at least one minor packet is packetized according to the second protocol, respectively.

Also according to the present invention, a method for processing traffics includes the steps of (a) assembling at least one input cell to generate at least one data packet and segmenting another at least one data packet corresponding to said generated at least one data packet to generate at least one cells corresponding to said at least one input cell; (b) extracting at least one sub-data packet including at least one header and at least one predetermined payload, from said generated at least one data packet; (c) analyzing at least one field of at least one lower layer protocol header of said at least one sub-data packet, carrying out processing related to a lower layer protocol with respect to said at least one sub-data packet; (d) analyzing at least one lower layer protocol address of said at least one sub-data packet to decide one or more paths through which said at least one sub-data packet is to be transmitted to at least one external device; and (e) processing at least one of at least one header and at least one payload of at least one higher layer protocol of said at least one sub-data packet, and outputting said processed at least one of said at least one header and said at least one payload.

Further provided is the step of (a1) storing said at least one generated data packet , after the step (a). The step (a) includes the sub-steps of (a2) assembling said at least one input cell to generate said at least one data packet; and (a3) segmenting said another at least one data packet to generate said at least one cell and outputting said at least one cell.

The step (e) includes the sub-steps of (e1) analyzing at least one header of at least one major packet occupying said at least one sub-data packet input from the outside in a ratio greater than or equal to a predetermined ratio, deciding if additional processing related to a first protocol is required with respect to at least one payload of said at least one major packet, and bypassing at least one minor packet occupying said at least one sub-data packet in a ratio less than the predetermined ratio; and (e2) carrying out the additional processing with respect to said at least one major packet payload, if it is decided that the additional processing is required with respect to the major packet payload in step (e1). Said at least one major packet is packetized according to the first protocol corresponding to said at least one major packet payload, and said at least one minor packet is packetized according to a second protocol corresponding to at least one payload of said at least one minor packet, respectively.

According to the present invention, a traffic processor is a single network system into which a master system and slave systems are combined to make traffic processing possible.

### BRIEF DESCRIPTION OF THE DRAWINGS

The above-described objectives and features of the present invention can be clarified by describing preferred embodiments in detail with reference to the accompanying drawings:

FIG. 1 is a block diagram showing a basic configuration of the conventional network system;

FIG. 2 is a general block diagram of the conventional network system having a master and slaves, showing an embodiment of the system shown in FIG. 1;

FIG. 3 is a block diagram showing a traffic processing apparatus according to a preferred embodiment of the present invention;

FIG. 4 is a block diagram showing the higher layer protocol processing portion of FIG. 3 in greater detail;

FIG. 5 is a flow chart of a traffic processing method according to the present invention; and

FIG. 6 is a flow chart of a higher layer protocol processing method according to the present invention.

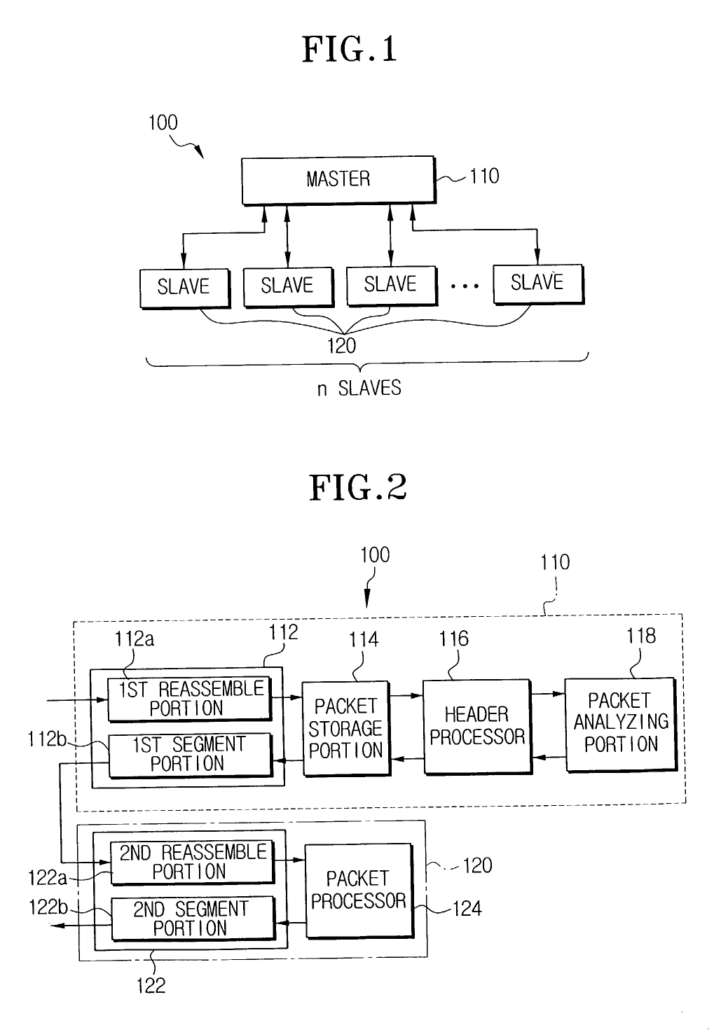

### DETAILED DESCRIPTION OF THE PREFERRED EMBODIMENT

A preferred embodiment of the present invention will now be described with reference to the accompanying drawings.

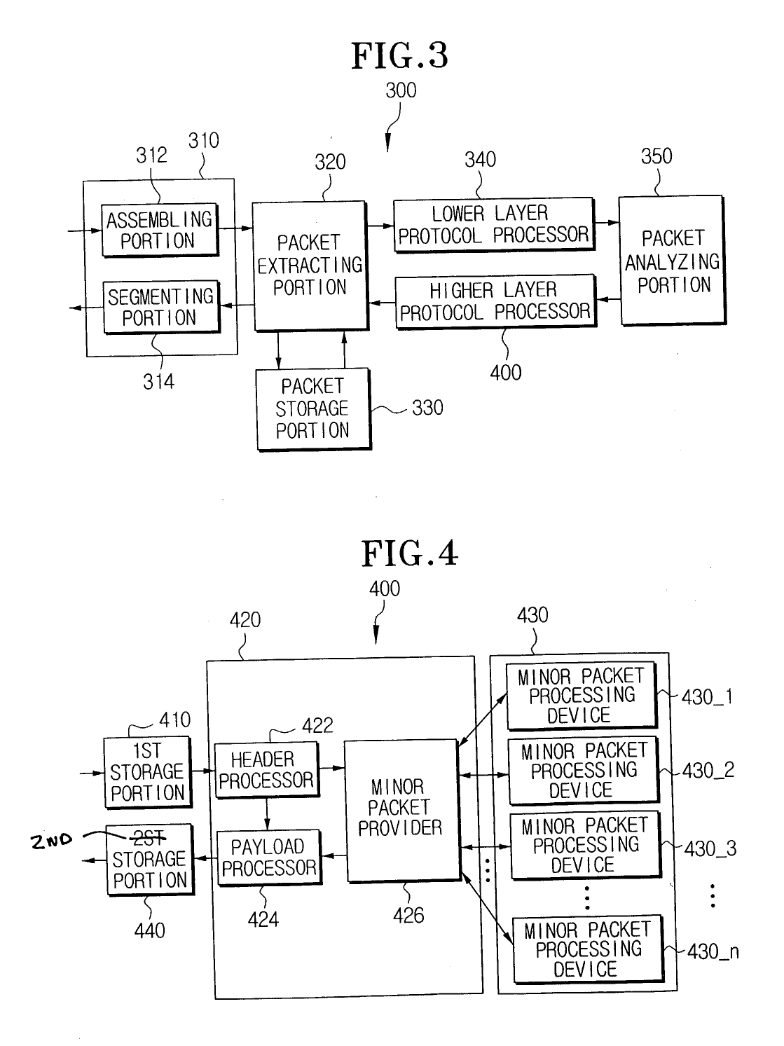

FIG. 3 is a block diagram showing a basic configuration of a traffic processing apparatus according to a preferred embodiment of the present invention.

Referring to FIG. 3, the traffic processing apparatus 300 according to the present invention includes an assembling and segmenting portion 310, a packet extracting portion 320, a packet storage portion 330, a lower layer protocol processor 340, a packet analyzing portion 350 and a higher layer protocol processor 400.

The traffic processing apparatus 300 processes traffic input from the outside. The assembling and segmenting portion 310 relates to a SAR layer belonging to a second layer of the OSI 7 layers.

The assembling and segmenting portion 310 includes an assembling portion 312 and a segmenting portion 314. The assembling portion 312 assembles cells received from the outside to generate data packets. The received cells are ATM- or Ethernet-based.

Each generated data packet is comprised of a header corresponding to the second layer, an IP header corresponding to a third layer, a protocol header corresponding to a higher layer of the IP of the OSI 7 layers, and a payload. Hereinafter, the IP and a protocol corresponding to the higher layer of the IP are called a lower layer protocol and a higher layer protocol, respectively.

The generated data packets are stored in the packet storage portion 330 by the packet extracting portion 320. The packet extracting portion 320 preferably performs a similar function as that of a Direct Memory Access (DMA). The DMA serves to transmit data packets to a memory or to peripheral devices without the intervention of a CPU. The packet extracting portion 320 extracts sub-data packets from the data packets stored in the packet storage portion 330.

The sub-data packets are comprised of an IP header corresponding to the third layer, a higher layer protocol header corresponding to the higher layer of the IP, and a part of the payload. Subsequently, only residue payloads of the data packets are stored in the packet storage portion 330. The sub-data means the front portion of a data packet and its size can be selected by a user.

The sub-data packets extracted by the packet extracting portion 330 are input to the lower layer protocol processor 340. The lower layer protocol processor 340 processes lower layer protocols of the sub-data packets, i.e., the IP headers. That is, the lower layer protocol processor 340 extracts necessary fields from the IP headers and classifies the sub-data packets based on the extracted fields.

Processing methods for the data packets depend on the classifying method or classifying criterion. The lower layer protocol processor 340 analyzes specific fields, detects errors of the transmitted sub-data packets by referring to contents of checksum, etc., and corrects the errors.

The packet analyzing portion 350 analyzes the sub-data packets input from the lower layer protocol processor 340 to decide the processing method and transmission directions of the data packets at high speed. That is, the packet analyzing portion 350 analyzes addresses of the IPs, a part of the subdata packets, and decides the paths or the processing method by which the sub-data packets are transmitted. The sub-data packets analyzed in the packet analyzing portion 350 are input to the higher layer protocol processor 400.

FIG. 4 is a block diagram showing the higher layer protocol processing portion of FIG. 3 in greater detail.

The higher layer protocol processor 400 is the same as the protocol processing apparatus 400 according to the present invention. The higher layer protocol processor 400 analyzes higher layer protocol headers of the sub-data packets input from the packet analyzing portions 350. The higher layer protocols have a transmission control protocol (TCP), a user data-gram protocol (UDP), a fragmentation protocol (FRP), hyper text transfer protocol (HTTP), and simple mail transfer protocol (SMTP), etc.

Referring to FIG. 4, the higher layer protocol processor 400 of the present invention includes a first storage portion 410, a major packet processor 420, a minor packet processor 430 and a second storage portion 440.

The major packet processor 420 processes first protocol headers and/or first protocol payloads of the major packets among the sub-data packets. The major packet processor 420 includes a header processor 422, a payload processor 424, and a minor packet provider 426.

The first storage portion 410 is a buffer for storing the sub-data packets temporarily input from the packet analyzing portion 350. The temporarily stored sub-data packets are input to the header processor 422 in sequential order or in any optional order.

The header processor 422 divides the sub-data packets into major and minor packets according to the higher layer protocol, the higher layer protocol being a part of the sub-data packets. The major and minor packets can be divided by a certain criterion in a network system to which the present invention is applied.

For example, if the higher layer protocols of the sub-data packets are the ones occupying the higher layer protocols used in the network system in a ratio greater than or equal to a predetermined ratio, the header processor 422 recognizes the sub-data packets as the major packets.

On the other hand, if the higher layer protocols of the sub-data packets are the ones occupying traffic of the network system of the present invention in a ratio below the predetermined ratio, the header processor 422 recognizes the sub-data packets as the minor packets. Hereinafter, the higher layer protocols of the major and minor packets are called first and second protocols, respectively. The major packets are packetized according to the first protocol header and/or payload, while the minor packets are packetized according to the second protocol header and/or payload.

The header processor 422 processes the first protocol headers of the major packets, when it decides the input sub-data packets to be the major packets. Namely, the header processor 422 extracts specific fields from the first protocol headers to analyze and process them. Also, the header processor 422 analyzes the first protocol headers to decide if additional processing is required in relation to the first protocol corresponding to the payload. If the header processor 422 decides that additional processing is required for the first protocol, the payload processor 424 carries out additional processing in relation to the payloads of the major packets. On the other hand, if the header processor 422 decides that additional processing is not required for the first protocol, the header processor 422 makes the major packets bypass the payload processor 424 to be input to the second storage portion 440. For example, the header processor 422 analyzes the first protocol headers to decide if there occur errors in the payloads and if the errors need to be corrected. If the header processor 422 decides that the payloads need correction, the payload processor 424 corrects the overall, or, a part of the payloads of the main packets. On the other hand, if the header processor 422 decides that the payloads need no correction, the header processor 422 makes the main packets bypass the payload processor 424 and be input to the second storage portion 440.

Meanwhile, if the header processor 422 determines that the input subdata packets are minor packets, it transmits the minor packets to the minor packet provider 426. The minor packet provider 426 distributes the minor packets received from the header processor 426 over the minor packet processor 430, adaptively.

The minor packet processor 430 includes one minor packet processing device or more 430_1, 430_2, . . . , 430_{—}n, where n is a positive number. The minor packet processor 430 can be set to perform functions only corresponding to the second protocols of the minor packets, or functions corresponding to all of the protocols.

In the former case, the minor packet provider 426 selects at least one minor packet processing device 430_1, 430_2, . . . , 430_{—}n that can process the second protocols, sets the order of priority, and then distributes and provides the minor packets. For example, if the second protocols of the minor packets are FTP among the potential protocols of TCP, UDP and FTP, the minor packet provider 426 selects at least one minor packet processing device 430_1, 430_2, . . . , 430_{—}n that can process FTP, sets the order of priority, and then provides the minor packets to the selected at least one minor packet processing device.

On the other hand, in the latter case, each of the minor packet processing devices 430_1, 430_2, . . . , 430_{—}n can process all of the protocols including TCP, UDP, FTP, etc. Therefore, the minor packet provider 426 selects any one of the minor packet processing devices 430_1, 430_2, . . . , 430_{—}n, which can process protocols in a shortest amount of time or one which has the fewest number of protocols to be processed, distributes and provides the minor packets sequentially.

The minor packets processor 430 processes the payloads and the second protocol headers of the minor packets distributed and provided by the minor packet provider 426. In other words, the minor packet processor 430 extracts specific fields from the second protocol headers, analyzes and processes them.

Using the second protocol header, it is determined whether to process the payloads or not, and the entire payload or a part of the payload is processed. The processed minor packets are bypassed by the minor packet provider 426 and the payload processor 424, to be input to the second storage portion 440.

The second storage portion 440 temporarily stores the major or minor packets input from the header processor 422 or the minor packet processor 430. The second storage portion 440 outputs the major and minor packets to the packet extracting portion 320 in sequential order or in any optional order. If the sub-data packets are input as the major packets or the minor packets, the packet extracting portion 320 extracts residue payloads corresponding to the sub-data packets input from the packet storage portion 330. The packet extracting portion 320 connects the extracted residue payloads with the subdata packets to regenerate initial data packets generated in the assembling portion 312. The regenerated data packets are input to the segmenting portion 314. The segmenting portion 314 segments the input data packets into initial plural cells as input to the assembling portion 312.

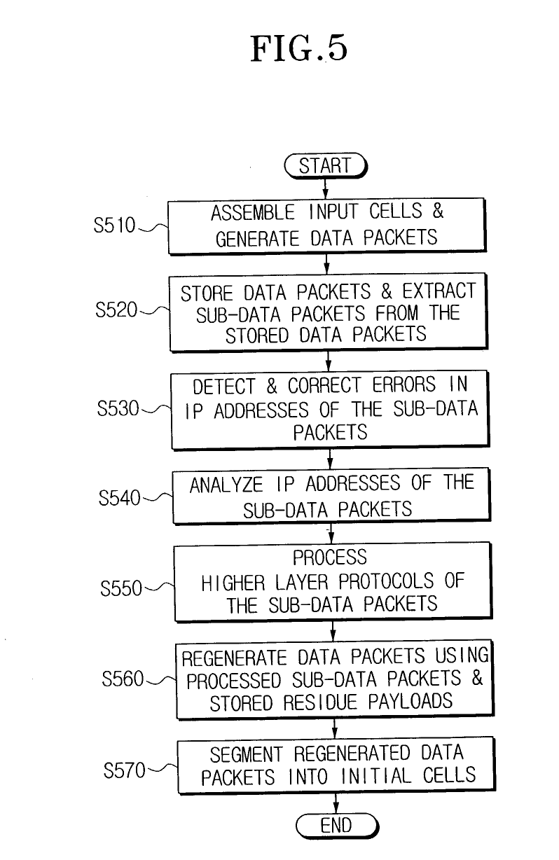

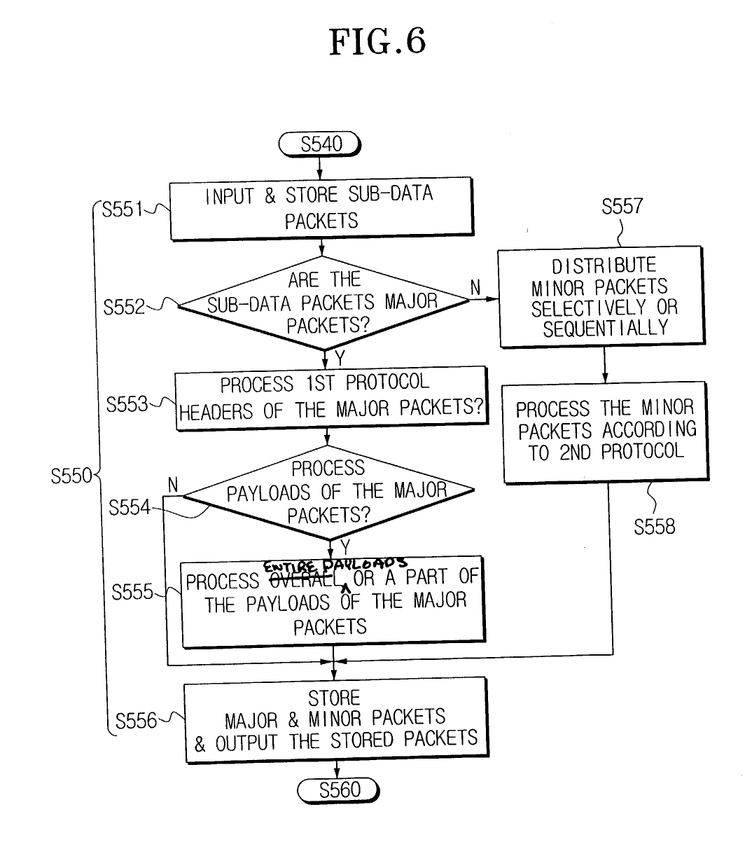

FIG. 5 is a flow chart of a traffic processing method according to preferred embodiment of the present invention. FIG. 6 is a flow chart of a higher layer protocol processing method of the FIG. 5 according to the present invention.

Referring to FIG. 5, cells transmitted from the outside are assembled into data packets (step S510). The transmitted cells are ATM or Ethernet-based. The generated data packets are stored, and only the sub-data packets are extracted from the data packets (step S520).

The sub-data packets are comprised of IP headers of a third layer corresponding to a lower layer, higher layer protocol headers corresponding to the higher layer of IP and a part of a payload. Based on the above steps, only the residue payloads of the data packets are stored.

If the sub-data packets are extracted, the IP header fields of the extracted sub-data packets are detected and analyzed, and processes related to the lower layer protocol are performed on the sub-data packets (step S530). For example, if the fields are confirmed as containing errors, the errors of the sub-data packets are corrected . After the above step, the IP addresses of the sub-data packets are analyzed (step S540). Sequentially, paths through which the data packets are transmitted to the external devices and a processing method, etc. are decided in the step S540.

After analyzing the IP addresses, some predetermined processes for the higher layer protocols of the sub-data packets are performed (S550). In step S550, the higher layer protocol headers are analyzed to detect specific fields and correct the fields required by the protocol such as error-occurred fields. According to the analyzed header information, it is decided whether the payloads are added or not.

Referring to FIG. 6, the step S550 is divided into steps S551 through S558. The sub-data packets whose IP addresses are analyzed in the step S540 are temporarily stored in a device like a buffer (step S551). The sub-data packets are divided into the major or minor packets according to a certain criterion applied only to the network system of the present invention. The criterion is applied to the higher layer protocols of the sub-data packets. The higher layer protocols of the major packets and the higher layer protocols of the minor packets are called as first and second protocols, respectively.

If the temporarily stored sub-data packets are decided to be the major packets (step S552), the first protocol headers of the major packets are analyzed and processed (step S553). In step S553, fields of the first protocol headers are detected and analyzed, and if necessary, certain fields are corrected according to the protocol. For example, if an error is detected in the field detection and analysis, the field is corrected.

If the payloads of the major packets are determined to be additionally processed in relation to the first protocol according to the analysis of the first protocol headers (step S554), the entire payload or a part of the payload of the major packets are additionally processed according to the predetermined rules (step S555).

After processes for the first protocols of the major packets are completed, the major packets are stored temporarily and output in sequential order or in any optional order (step S556). If the payloads of the major packets are determined not to be processed in step S554, step S556 is performed.

In the step S552, if the sub-data packets are determined to be minor packets, then the minor packets are distributed selectively or sequentially (step S557) and processed according to the second protocol (step S558). In step S558, fields of the second protocol headers are detected and analyzed, and if necessary, for example when there is an error detected in the field detection and analysis, the field is corrected according to the protocol.

Further, if it is determined that the payloads of the minor packets are to be additionally processed with respect to the second protocol according to the analysis of the second protocol headers, the payloads of the minor packets are additionally processed. After processes for the second protocols of the minor packets are completed, the minor packets are stored temporarily and output in sequential order or in any optional order (step S556).

After the step of S550, any one of the major and minor packets, namely stored residue payloads for the corrected sub-data packets are extracted. The sub-data packets and extracted residue payloads are connected with each other to regenerate initial data packets (step S560). The regenerated data packets are re-segmented into cells of the initial input state and then transmitted to the external devices (step S570).

According to the apparatuses and methods for processing protocols and traffic of the present invention, diverse requirements according to the protocols of the data packets can be processed using the network system into which a master system and a plurality of slave systems are combined.

Subsequently, the size of the network system becomes smaller, and the speed of processing protocols is improved. Additionally, protocols can be processed efficiently by selecting and distributing them functionally or sequentially. Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An apparatus for processing protocols comprising:
a major packet processor for analyzing at least one header of at least one major packet occupying a total number of input packets input from an outside source in a ratio greater than or equal to a predetermined ratio, in order to carry out additional processing related to a first protocol corresponding to at least one of said at least one header and at least one payload of said at least one major packet; and
at least one minor packet processor for analyzing at least one header of at least one minor packet occupying the total number of packets in a ratio below the predetermined ratio, in order to carry out additional processing related to a second protocol corresponding to at least one of said at least one header and at least one payload of said at least one minor packet;
wherein said at least one major packet is packetized according to the first protocol, and said at least one minor packet is packetized according to the second protocol, respectively.

2. The apparatus for processing protocols according to claim 1, further comprising:
a first storage portion for storing the total number of input packets input from the outside; and
a second storage portion for storing at least one of said at least one major packet and said at least one minor packet provided from at least one of the major packet processor and the minor packet processor, respectively, and outputting said at least one of said at least one major packet and said at least one minor packet to an outside destination.

3. The apparatus for processing protocols according to claim 1, wherein the major packet processor comprises:
a header processor for bypassing said at least one minor packet input from the outside, analyzing said at least one major packet header, and deciding if said additional processing related to the first protocol is required with respect to said at least one payload of said at least one major packet;
a payload processor for carrying out the additional processing if the header processor decides that the additional processing related to the first protocol is required with respect to said at least one payload of said at least one major packet; and
a minor packet provider for providing said at least one minor packet bypassed by the header processor, to the minor packet processor.

4. The apparatus for processing protocols according to claim 3, wherein the payload processor bypasses said at least one major packet if the header processor does not decide that the additional processing is required with respect to said at least one payload of said at least one major packet.

5. The apparatus for processing protocols according to claim 3, wherein the minor packet provider selects a minor packet processor corresponding to the second protocol and provides said at least one minor packet bypassed to the selected minor packet processor.

6. The apparatus for processing protocols according to claim 3, wherein the minor packet provider selects at least one minor packet processor that is in an inactive state, sets an order of priority, and provides said at least one minor packet to the selected at least one minor packet processor.

7. A method for processing protocols comprising the steps of:
(a) analyzing at least one major packet header occupying a total number of packets input from an outside source in a ratio greater than or equal to a predetermined ratio, deciding if additional processing related to a first protocol is required with respect to at least one major packet payload, and bypassing at least one minor packet occupying the total number of packets in a ratio below the predetermined ratio; and
(b) carrying out the additional processing with respect to said at least one major packet payload if it is decided that the additional processing is required with respect to said at least one major packet payload in the step (a);
wherein said at least one major packet is packetized according to said first protocol corresponding to said at least one major packet header and payload, and said at least one minor packet is packetized according to a second protocol corresponding to said at least one minor packet header and payload, respectively.

8. The method for processing protocols according to claim 7, wherein said at least one major packet bypasses the processing performed in step (b) if it is not decided that the additional processing is required with respect to said at least one major packet payloads in the step (a).

9. The method for processing protocols according to claim 7, further comprising the steps of:
(c) providing said at least one minor packet bypassed in the step (a) to one or more minor packet processing devices; and
(d) analyzing at least one minor packet header to carry out the additional processing related to the second protocol with respect to at least one of headers and payloads of said at least one minor packet.

10. The method for processing protocols according to claim 9, wherein the step (c) comprises the sub-steps of selecting one of said one or more minor packet processing devices corresponding to the second protocol, and providing said at least one minor packet bypassed to the selected one of said one ore more minor packet processing devices.

11. The method for processing protocols according to claim 9, wherein the step (c) comprises the sub-steps of selecting at least one of said one or more minor packet processing devices that is in an inactive state, setting an order of priority, and providing said at least one minor packet to the selected at least one minor packet processing devices.

12. An apparatus for processing traffic comprising:
an assembling and segmenting portion for assembling at least one input cell to generate at least one first data packet and segmenting another at least one data packet corresponding to said at least one first data packet to regenerate the cells;
a packet extracting portion for extracting at least one sub-data packet including at least one header and at least one predetermined payload, from said generated at least one first data packet;
a lower layer protocol processing portion for analyzing lower layer protocol addresses of said at least one sub-data packet, and carrying out processing related to the lower layer protocol with respect to said at least one sub-data packet;
a packet analyzing portion for analyzing the lower layer protocol addresses of said at least one sub-data packet to determine one or more paths through which said at least one sub-data packet is to be transmitted to external devices; and
a higher layer protocol processing portion for processing at least one of at least one higher layer protocol header and at least one higher layer payload of said at least one sub-data packet to provide said at least one sub-data packet to the packet extracting portion.

13. The apparatus for processing traffic according to claim 12, further comprising:
a payload storage portion for storing at least one residue payload excluding said at least one sub-data packet from said generated at least one first data packet .

14. The apparatus for processing traffic according to claim 12, wherein the assembling and segmenting portion comprises:
an assembling portion for assembling said at least one input cell to generate said at least one first data packet; and
a segmenting portion for segmenting said another at least one data packet to regenerate at least one cell, and outputting said at least one cell.

15. The apparatus for processing traffic according to claim 14, wherein the higher layer protocol processing portion comprises:
a major packet processing portion for analyzing at least one header of at least one major packet occupying said at least one sub-data packet input in a ratio greater than or equal to a predetermined ratio, and carrying out additional processing related to a first protocol corresponding to at least one of said at least one header of said at least one major packet and at least one payload of said at least one major packet; and
at least one minor packet processing portion for analyzing at least one header of at least one minor packet occupying said at least one sub-data packet input in a ratio less than the predetermined ratio, and carrying out additional processing related to a second protocol corresponding to at least one of said at least one header and at least one payload of said at least one minor packet;
wherein said at least one major packet is packetized according to the first protocol, and said at least one minor packet is packetized according to the second protocol, respectively.

16. A method for processing traffic comprising the steps of:
(a) assembling at least one input cell to generate at least one data packet and segmenting another at least one data packet corresponding to said generated at least one data packet to generate at least one cells corresponding to said at least one input cell;
(b) extracting at least one sub-data packet including at least one header and at least one predetermined payload, from said generated at least one data packet;
(c) analyzing at least one field of at least one lower layer protocol header of said at least one sub-data packet, carrying out processing related to a lower layer protocol with respect to said at least one sub-data packet;
(d) analyzing at least one lower layer protocol address of said at least one sub-data packet to decide one or more paths through which said at least one sub-data packet is to be transmitted to at least one external device; and
(e) processing at least one of at least one header and at least one payload of at least one higher layer protocol of said at least one sub-data packet, and outputting said processed at least one of said at least one header and said at least one payload.

17. The method for processing traffic according to claim 16, further comprising the step of:
(a1) storing said at least one generated data packet, after the step (a).

18. The method for processing traffic according to claim 16, wherein the step (a) comprises the sub-steps of:
(a2) assembling said at least one input cell to generate said at least one data packet; and
(a3) segmenting said another at least one data packet to generate said at least one cell and outputting said at least one cell.

19. The method for processing traffic according to claim 18, wherein the step (e) comprises the sub-steps of:
(e1) analyzing at least one header of at least one major packet occupying said at least one sub-data packet input from the outside in a ratio greater than or equal to a predetermined ratio, deciding if additional processing related to a first protocol is required with respect to at least one payload of said at least one major packet, and bypassing at least one minor packet occupying said at least one sub-data packet in a ratio less than the predetermined ratio; and
(e2) carrying out the additional processing with respect to said at least one major packet payload, if it is decided that the additional processing is required with respect to the major packet payload in step (e1);
wherein said at least one major packet is packetized according to the first protocol corresponding to said at least one major packet payload, and said at least one minor packet is packetized according to a second protocol corresponding to at least one payload of said at least one minor packet, respectively.
